(19) United States
(12) Patent Application Publication
(10) Pub. No.: US 2014/0096540 A1
(43) Pub. Date: Apr. 10, 2014

(54) ZERO LOSS COOLDOWN OF CRYOGENIC PUMP

(71) Applicant: Stephen Foster, Birchgrove (AU)

(72) Inventor: Stephen Foster, Birchgrove (AU)

(21) Appl. No.: 14/039,781

(22) Filed: Sep. 27, 2013

Related U.S. Application Data
(60) Provisional application No. 61/709,473, filed on Oct. 4, 2012.

(51) Int. Cl. F17C 7/02

(52) U.S. Cl. CPC F17C 7/02
USPC 62/50.6

(57) ABSTRACT

A system for cryogenic liquid delivery includes a cryogenic vacuum pump that operates to efficiently cool down the cryogenic delivery pump. The system is a no loss system that provides reduced cool down time at lower cost greater versatility and maintainability.

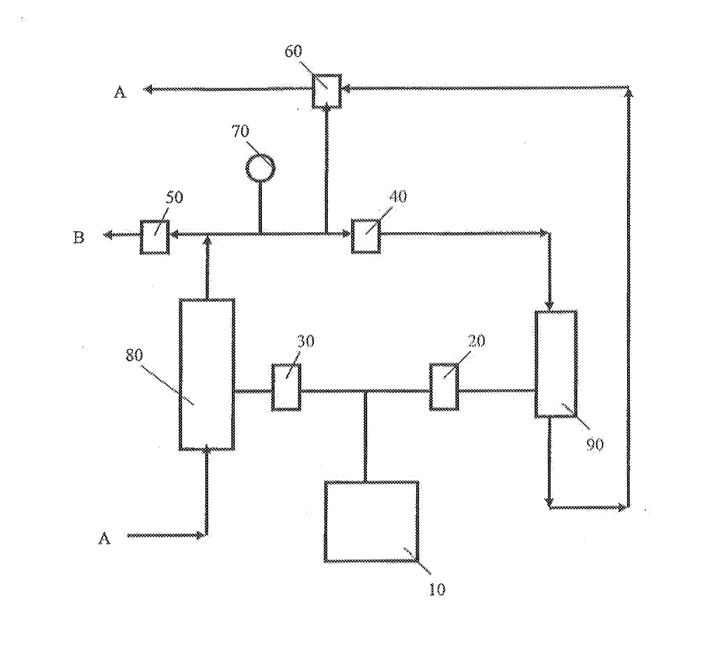

### FIELD OF THE INVENTION

The present invention relates to the delivery of cryogenic liquids.

### BACKGROUND OF THE INVENTION

In order to avoid damage to pumping systems for cryogenic liquids, the cryogenic liquid needs to flow through the pumping system continuously in order to maintain the pump parts at a low enough temperature to avoid cold shock or differential heating of the impellers. This results in a loss of cryogenic liquid of two percent or more.

There is a need in the art for improvements to cryogenic liquid delivery.

### SUMMARY OF THE PRESENT INVENTION

The invention provides an improved system for cryogenic liquid delivery. The system of the invention includes a cryogenic vacuum pump that operates to efficiently cool down the cryogenic delivery pump.

### BRIEF DESCRIPTION OF THE DRAWINGS

The figure is a schematic diagram of a cryogenic liquid delivery system according to the invention.

### DETAILED DESCRIPTION OF THE INVENTION

The invention provides a system for deliver of cryogenic liquids. The invention will be described in detail with reference to the drawing figure. The figure is a schematic diagram of a system for delivery of cryogenic liquid, comprising a motor 10, communicating with a cryogenic vacuum pump 90 through clutch pack 20 and with cryogenic delivery pump 80 through clutch pack 30. The system also include valves 40, 50, and 60 and a resistance temperature device (RTD) 70.

To operate the system of the invention, the following sequence is carried out. Motor 10 is started and clutch pack 20 is engaged. Valve 40 is then opened. At this time, valve 60 is closed and clutch pack 30 is disengaged. This results in cryogenic vacuum pump 90 operating and drawing cold gas from a tank or vehicle A through cryogenic delivery pump 80. The cold gas acts to cool the cryogenic delivery pump 80 to the point that it can safely be operated. The cold gas continues to be drawn through the cryogenic delivery pump 80 until the RTD 70 indicates a preset temperature has been reached. In an alternative, the RTD 70 could be replaced with a temperature switch. At this point, valve 60 is opened and valve 40 is closed. In addition, clutch pack 20 is disengaged and clutch pack 30 is engaged. This ceases operation of the cryogenic vacuum pump 90 and begins operation of the cryogenic delivery pump 80. Cold gas is now pulled from the tank or vehicle A through the cryogenic delivery pump 80 and returned to the tank or vehicle A via valve 60. This flow of cold gas through the cryogenic delivery pump 80 continues until the RTD 70 indicates that the cryogenic delivery pump 80 has reached a sufficiently low temperature for delivery. Once that temperature has been reached, valve 60 is closed and valve 50 is opened. This results in delivery of the cryogenic liquid to the intended receiving tank B. When delivery has been completed valve 50 is closed, clutch pack 30 is disengaged and motor 10 stops. Valve 60 is reopened so that any liquid remaining in the delivery pipes or hose is returned to the tank or vehicle A.

The system and operation of the invention provides numerous advantages. The system operates as a no loss system which is a significant improvement over the two percent or greater losses experienced by prior art systems. In addition, cool down time is significantly reduced. The process of cool down of the cryogenic delivery pump of the system of the invention is less than five minutes compared to cool down of between thirty minutes and as much as two hours depending on venting restrictions as required for prior art systems. Moreover, by integrating the cryogenic vacuum pump and cryogenic delivery pump into the same system, a more compact system is achieved which results in lower equipment costs and improved maintainability. The system of the invention also allows for more versatility and integration of temperature sensing components for protection of the rest of the equipment.

The system of the invention is useful for the delivery of cryogenic liquids. This may include delivery of liquefied natural gas (LNG) from a dispensing station or from a remote/unmanned start of a cryogenic process pump system.

It is anticipated that other embodiments and variations of the present invention will become readily apparent to the skilled artisan in the light of the foregoing description, and it is intended that such embodiments and variations likewise be included within the scope of the invention as set out in the appended claims.

What is claimed:

1. A cryogenic liquid delivery system comprising:
a cryogenic liquid source tank;
a cryogenic delivery pump having a first clutch pack for controlling operation of the delivery pump;
a cryogenic vacuum pump having a second clutch pack for controlling operation of the vacuum pump;
a motor for controlling the first clutch pack and the second clutch pack; and
a temperature sensing device;
wherein the delivery pump has an inlet communicating with the source tank, and an outlet that can alternatively communicate with the vacuum pump, the source tank or a receiving tank;
wherein the vacuum pump has an inlet communicating with the outlet of the delivery pump and an outlet communicating with the source tank; and
wherein the temperature sensing device communicates with the outlet of the delivery pump.

2. The system according to claim 1 wherein the temperature sensing device is a resistance temperature device or a temperature switch.

3. The system according to claim 1 wherein the cryogenic liquid is liquefied natural gas.

4. A method of delivering a cryogenic liquid from a cryogenic liquid delivery system comprising a cryogenic liquid source tank, a cryogenic delivery pump, and a cryogenic vacuum pump, the method comprising:
starting the cryogenic vacuum pump;
drawing cryogenic liquid from the source tank through the delivery pump by operation of the vacuum pump;
returning the cryogenic liquid to the source tank;
sensing the temperature of the cryogenic liquid leaving the delivery pump;
upon sensing a predetermined temperature of the cryogenic liquid leaving the delivery pump, stopping the vacuum pump and starting the delivery pump;
drawing cryogenic liquid from the source tank by operation of the delivery pump;
returning the cryogenic liquid to the source tank;
sensing the temperature of the cryogenic liquid leaving the delivery pump;
upon sensing a predetermined temperature of the cryogenic liquid leaving the delivery pump, delivering the cryogenic liquid to a receiving tank.

5. The method according to claim 4 wherein the steps of sensing the temperature of the cryogenic liquid comprise sensing the temperature with a resistance temperature device or a temperature switch.

6. The method according to claim 4 wherein the cryogenic liquid is liquefied natural gas.
